(19) United States
(12) Patent Application Publication
(10) Pub. No.: US 2017/0053014 A1
(43) Pub. Date: Feb. 23, 2017

(54) RECORDS MANAGEMENT

(71) Applicant: salesforce.com, inc., San Francisco, CA (US)

(72) Inventor: Ryan Edward Lavallee, Kinnelon, NJ (US)

(21) Appl. No.: 14/829,901

(22) Filed: Aug. 19, 2015

(51) Int. Cl. G06F 17/30

(52) U.S. Cl. CPC G06F 17/30598; G06F 17/30011; G06F 17/30377

(57) ABSTRACT

Techniques for electronic records management. Electronic records are stored in databases, each having a different data model and classification scheme. The electronic records created in source systems are indexed with the index having a pointer to each electronic record in the source systems. The index is updated with changes to electronic records. The document management agent applies retention rules and tracks electronic records against the appropriate retention schedule. Records that are scheduled to be dispositioned are dispositioned, and when the disposition is appropriate, the document management agent also invokes deletion or exportation of the corresponding electronic records.

### TECHNICAL FIELD

Embodiments relate to techniques for managing retention of electronic records. More particularly, embodiments relate to techniques for unified records management across multiple source systems having different data formats and classification schemes.

### BACKGROUND

Organizations in both the public and private sectors are required to retain certain records of information for period of time in order to comply with laws and regulations pertaining to their business. When deleting business information, including emails, most companies delete unstructured data based on a retention schedule to protect themselves from potential fines for failing to produce artifacts during legal discovery. Most Document Management systems include records management functionality to meet an organization's needs for data retention for data stored within that system. In addition, data archiving solutions provide a mechanism for importing data from Document Management systems, as well as email systems, and applying retention rules.

As data within organizations continues to grow at exponential levels, it is increasingly challenging to ensure that data is retained and dispositioned in a manner compliant with Records Management policies. Collaboration and messaging platforms are eclipsing email as sources of unstructured data, yet lack the capabilities to apply retention rules or limit an organization to their own rudimentary retention capabilities. With more business applications offering their own collaboration capabilities, the problem is made even more complex. Organizations take on even more risks with Bring Your Own Device (BYOD) policies that may introduce new applications into the environment with little or no oversight.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment is a block diagram of one embodiment of the architecture of a cloud based records management service.

FIG. 2 is a block diagram of one embodiment of mapping functionality for use with ah cloud based records management system.

FIG. 3 is an example data flow for one embodiment of record capture processing utilizing a cloud based records management system.

FIG. 4 is an example data flow for one embodiment of record disposition processing utilizing a cloud based records management system.

FIG. 5 is an example data flow for one embodiment of search and hold functionality utilizing a cloud based records management system.

FIG. 6 is a block diagram of one embodiment of a cloud based records management system.

FIG. 7 illustrates a block diagram of an environment where an on-demand database service might be used.

FIG. 8 illustrates a detailed block diagram of an environment where an on-demand database service might be used.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

In one embodiment, a Records Management Cloud Service is a solution that can enable organizations to enforce a retention schedule, remain compliant with regulations and avoid potential legal fines. In one embodiment, a Records Management Service can provide functionality to tag any form of data as an official record and manage records across the entire environment with a single solution. In one embodiment, a single cloud based service can reduce the complexity of using multiple systems with their own inherent Records Management features and ensure that data stored all systems are included.

The techniques described herein can provide improved schedule creation. In one embodiment, the system can allow a Records Manager to define one, company wide retention schedule that could apply to data in any system. Because the retention schedule is stored in a single system, there is no need to ensure that changes are cascaded across environments. The service would also store Holds to indicate which retention schedules should be suspended based on current legal activity.

The techniques described herein can provide improved integration and mapping. In one embodiment, the system can connect with sources of data through a set of application program interfaces (APIs) to learn the data models of each system. In one embodiment, the Service can be configured to map specific date information from each connected system to calculate retention periods.

In one embodiment, the integration could also be utilized to automate the classification of data against the retention schedule. This classification could inherent or acquired. An inherent classification would involve tagging the record based on rules within the Records Management Service. Rules could be based on, for example, the source system, metadata on the record mapped to a classification or an intelligent classification based on record content. Acquired classification could take place, for example, when an imported record is classified with a file number in the source system.

In one embodiment, the techniques described herein can provide improved records data capture. In one embodiment, a process could index all data created in the source systems. As the index is built, it could maintain a pointer to each record in the source systems. In one embodiment, a batch process would subsequently update the index with changes to data. This may invoke a new classification or kick off a time trigger on a retention schedule. In one embodiment, as the index is continuously updated, it would apply retention rules and track records against the appropriate retention schedule.

In one embodiment, the techniques described herein can provide improved records disposition. In one embodiment, as the process runs it could identify which records are scheduled to be dispositioned. In one embodiment, a Records Manager could access the Service through a user interface to view records that are ready to be dispositioned. In one embodiment, when the disposition is approved, the service could use APIs to invoke the delete or export capabilities within the source systems. This would remove the need to store all records in one archive system and eliminate the risk of multiple copies existing in the environment after disposition.

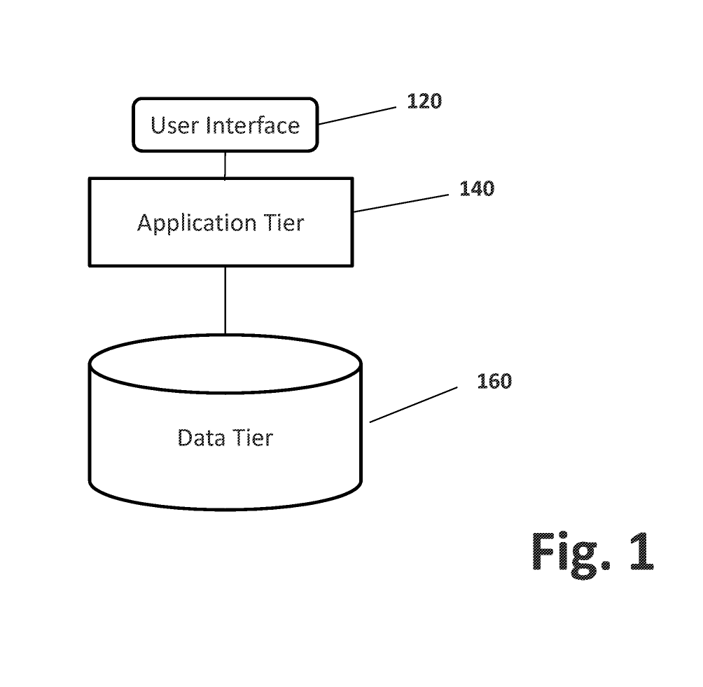

FIG. 1 is one embodiment is a block diagram of one embodiment of the architecture of a cloud based records management service (CBRMS). In one embodiment, the cloud based records management service described herein can be provided within an on-demand services environment, for example, a multitenant database environment, various embodiments of which are described in greater detail below. In other embodiments, the cloud based records management service described herein can be provided in other environments in which electronic documents are managed.

In one embodiment, user interface 120 is a web-based interface that allows a user access via, for example, a browser application. In other embodiments, user interface 120 can be an app (e.g., a records management app) or part of an application running on a computing device (e.g., desktop computer system, laptop computer system, tablet, smartphone). In one embodiment, user interface 120 allows a user to control records management functionality (e.g., determine/modify parameters, designate holds, modify the fileplan) and/or have access to relevant information (e.g., statistical information, status information), and/or authorize the disposition of records

In one embodiment, application tier 140 provides functionality to classify records, manage the retention of records (e.g., using timers and/or time triggers), manage the disposition of records, manage the fileplan, manage the retention schedule and/or provide reporting functionality. In one embodiment, application tier 140 can also function to provide indexing search and retrieval functionality. In one embodiment, application tier 140 can provide this functionality as one or more applications running on one or more computing devices, each having some memory and at least one processor.

In one embodiment, data tier 160 functions to provide functionality to store one or more fileplans, store one or more schedules, store one or more holds and record classification mappings, etc. In one embodiment, data tier 160 contains an index of records for search and retrieval. Data tier 160 can be, for example, one or more databases stored on one or more hardware storage devices coupled to operate in conjunction with application tier 140.

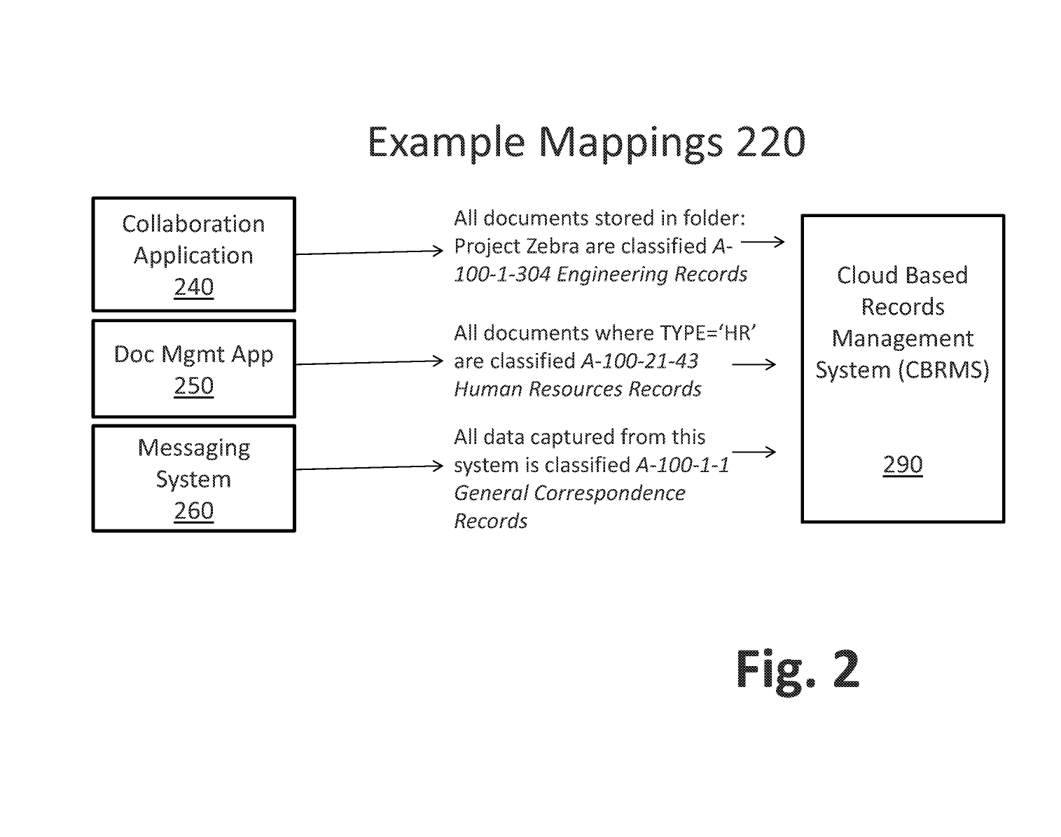

FIG. 2 is a block diagram of one embodiment of mapping functionality for use with a cloud based records management system, 290. In one embodiment, the cloud based records management system is configured to have access to multiple “source systems” that each store/generate/produce electronic documents to be managed. Example source systems are illustrated as collaboration application 240, document management application 250 and messaging system 260. Other types of source systems can also be supported.

In one embodiment, there is a mapping from the file plan stored in the cloud based records management service to rule that are used by the source systems. For example, within collaboration application 240, documents stored within a particular folder (e.g., Project Zebra) or workspace may map to a specific record classification (e.g., A-100-1-304 Engineering Records. As another example, within document management application 250, all documents with a specific type (e.g., HR) may map to a specific record classification (e.g., A-100-21-43 Human Resources Records). As another example, within messaging system 260, all data captured may map to a specific record classification (e.g., A-100-1-1 General Correspondence Records). If the source system manages metadata, the metadata may also be used to map to a file number. These are but a few examples.

More sophisticated mapping may also be provided. For example, data captured by messaging system 260 can be classified by creator, recipient and/or by key word(s). Each of the classifications above can also have subcategories.

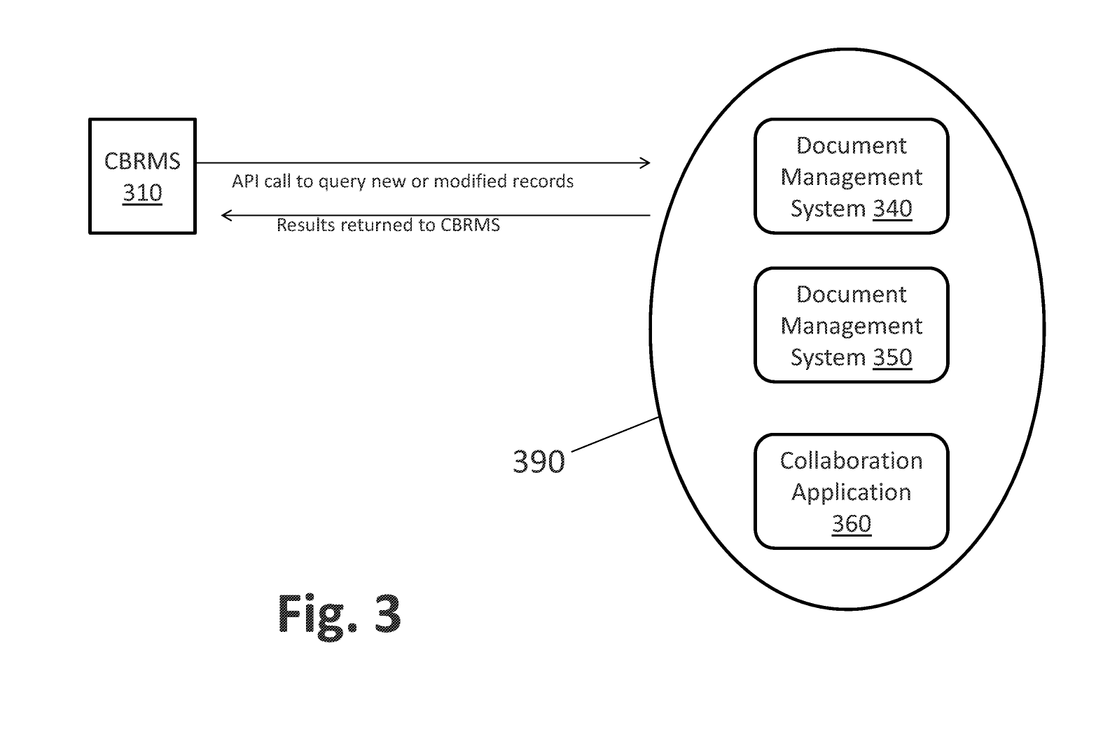

FIG. 3 is an example data flow for one embodiment of record capture processing utilizing a cloud based records management system. The components of FIG. 3 can all be part of a single computing environment or the components can be part of multiple networked computing environments.

In one embodiment, on a scheduled or realtime basis, cloud based records management system 310 queries each connected system (e.g., document management system 340, document management system 350, collaboration application 360) to determine creation and/or changes to records. In one embodiment, this can be accomplished via an application programming interface (API) call. This can be referred to as a records discovery phase. In one embodiment, document management system 340, document management system 350 and collaboration application 360 are each part of on-demand services environment 390; however, in other embodiments, they may be separate systems.

In one embodiment, the connected systems return pertinent metadata (e.g., record identifier(s), location(s), full text index) for records that have been created or changed. This metadata can be stored in cloud based records management system 310 as part of a record information storage phase.

In one embodiment, cloud based records management system 310 operates to classify the records utilizing the fileplan. This could be based on rules that evaluate the metadata and/or can be performed manually. The fileplan includes disposition rules that may be time triggered. Timers may be triggered by changes to record metadata. In one embodiment, cloud based records management system 310 starts and stops timers based on the rules when records are classified and/or updated. This can be referred to as the record classification/update phase.

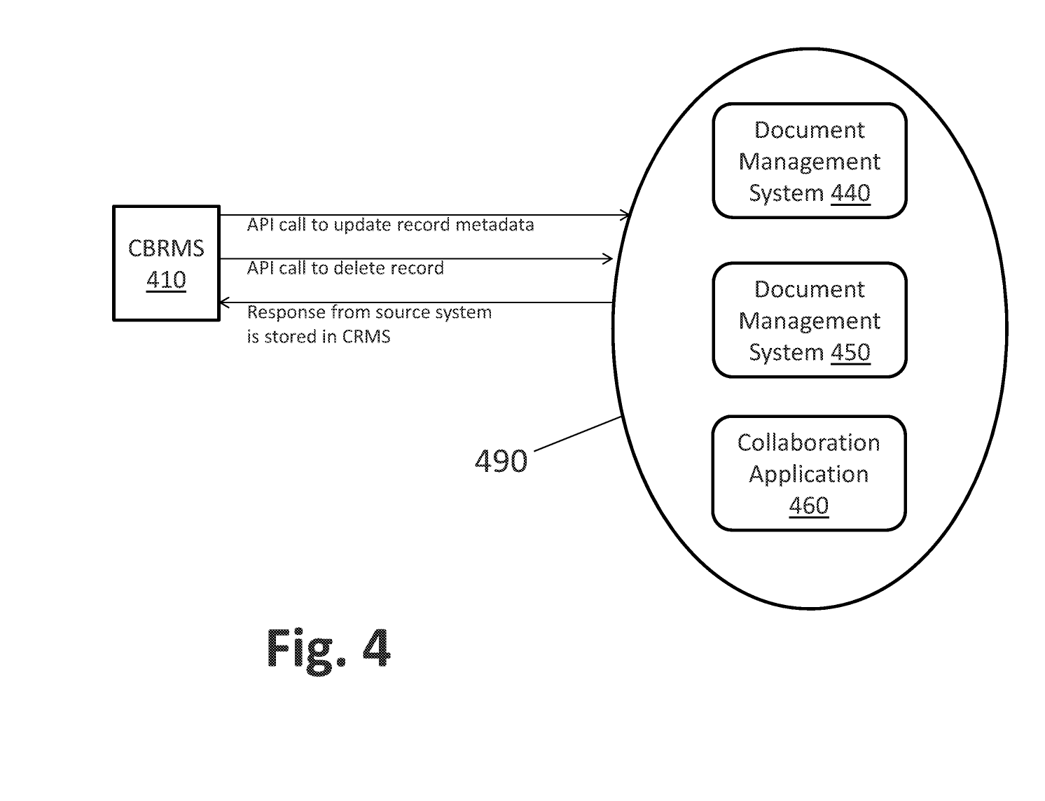

FIG. 4 is an example data flow for one embodiment of record disposition processing utilizing a cloud based records management system. As with FIG. 3, the components of FIG. 4 can all be part of a single computing environment or the components can be part of multiple networked computing environments.

In one embodiment, as timers expire, actions specified by the fileplan are executed (or caused to be executed) by cloud based records management system 410. The actions can include, for example, changes to metadata, commencement of additional timers and/or record destruction. In one embodiment, metadata in source systems (e.g., document management system 440, document management system 450, collaboration application 460) can be updated in response to action triggered/caused by cloud based records management system 410. In one embodiment, document management system 440, document management system 450 and collaboration application 460 are each part of on-demand services environment 490; however, in other embodiments, they may be separate systems.

In one embodiment, if the fileplan calls for a record to be deleted, cloud based records management system 410 can send a delete command to the appropriate source system (e.g., via the API). The delete action may, or may not, require authorization of a user through a user interface. In one embodiment, the record metadata is updated to include deletion information (e.g., time, data, authorized user). In one embodiment, the record metadata is retained in cloud based records management system 410 indefinitely.

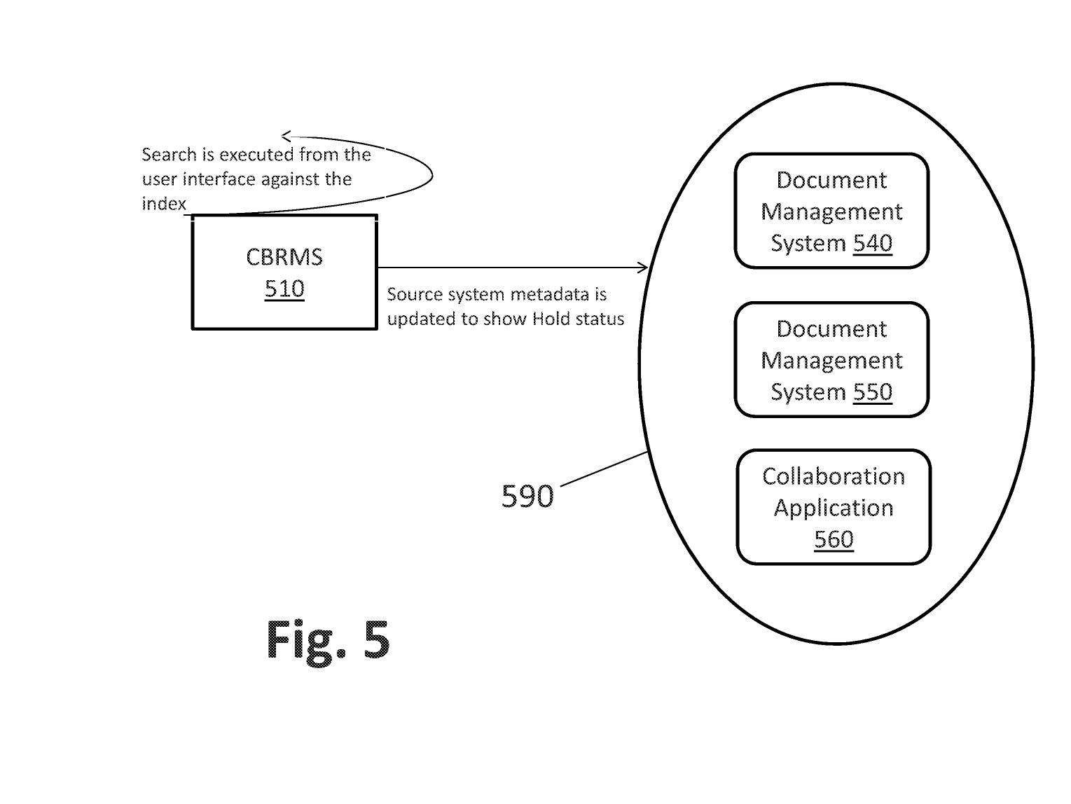

FIG. 5 is an example data flow for one embodiment of search and hold functionality utilizing a cloud based records management system. In one embodiment, a search can be executed from the cloud based records management system 510 user interface against the index stored in cloud based records management system 510. In one embodiment, search results are returned within the user interface.

A search may be performed to initiate a hold. A hold may be placed on the search results via the user interface. In one embodiment, records on hold will be excluded from disposition. In one embodiment, cloud based records management system 510 causes source system (e.g., document management system 540, document management system 550, collaboration application 560) to update metadata for relevant records to indicate the hold status. In one embodiment, document management system 540, document management system 550 and collaboration application 560 are each part of on-demand services environment 590; however, in other embodiments, they may be separate systems. In one embodiment, this may be accomplished via one or more calls (e.g., API calls) by cloud based records management system 510 to one or more source system.

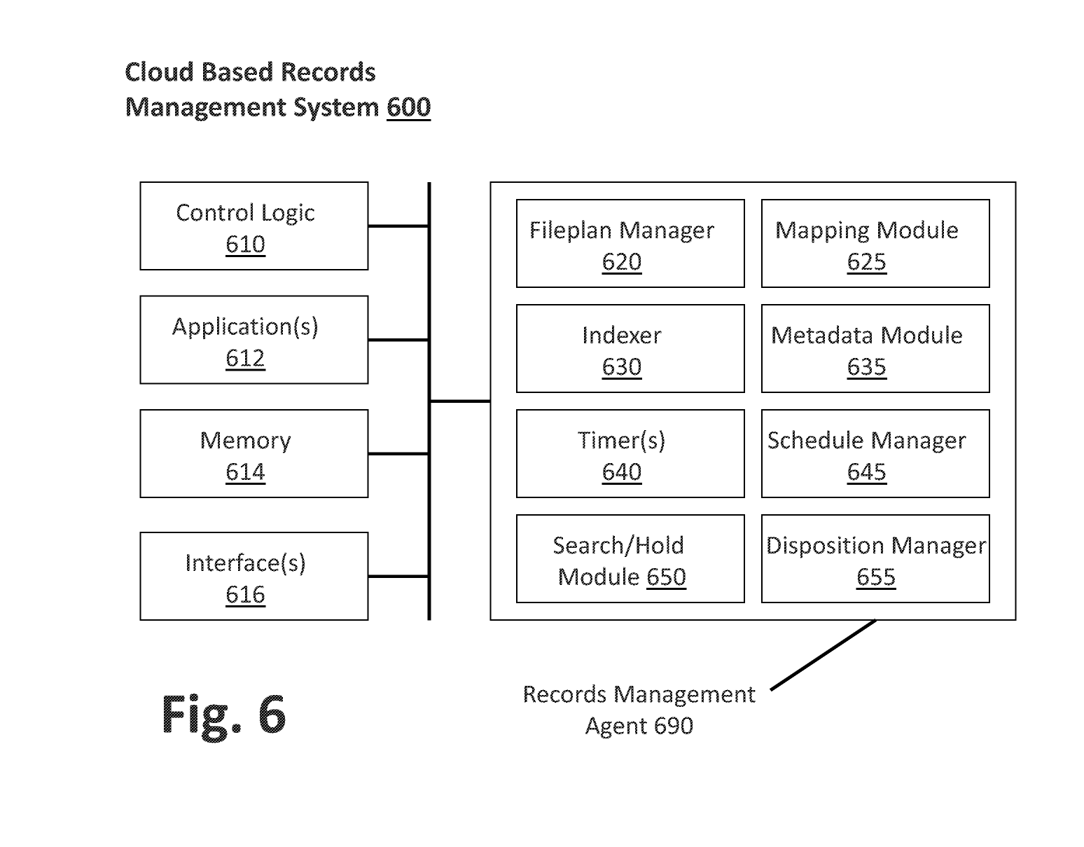

FIG. 6 is a block diagram of one embodiment of a cloud based records management system. In one embodiment, cloud based records management system 600 includes control logic 610, which implements logical functional control to direct operation of cloud based records management system 600, and/or hardware associated with directing operation of cloud based records management system 600. Logic may be hardware logic circuits and/or software routines.

In one embodiment, cloud based records management system 600 includes one or more applications 612, which represent code sequence and/or programs that provide instructions to control logic 610. Applications can provide various functional components of cloud based records management system 600.

Cloud based records management system 600 includes memory 614, which represents a memory device and/or access to a memory resource for storing data and/or instructions. Memory 614 may include memory local to cloud based records management system 600, as well as, or alternatively, including memory of the host system on which cloud based records management system 600 resides.

In one embodiment, cloud based records management system 600 also includes one or more interfaces 616, which represent access interfaces to/from (an input/output interface) cloud based records management system 600 with regard to entities (electronic or human) external to cloud based records management system 600. Interface(s) 616 can include, for example, the various APIs utilized to perform the functionality described above and/or the user interface discussed above. Other and/or different and/or additional interfaces can also be provided.

Cloud based records management system 600 also includes records management agent 690, which includes one or more functions or modules that enable cloud based records management system 600 to provide the records management services as described above. The example of FIG. 6 provides several modules that may be included in records management agent 690; however, different and/or additional modules may also be included. Example modules that may be involved in providing the records management functionality include fileplan manager 620, mapping module 625, indexer 630, metadata module 635, timer(s) 640, schedule manager 645, search/hold module 650 and disposition manager 655. The modules of records management agent 690 can be hardware, software or a combination thereof.

In one embodiment, fileplan manager 620 operates to manage the fileplan to be utilized. Fileplan manager 620 operates to manage and/or provide an outline of records (e.g., series, sequences, organization, locations), file transfer parameters, file retention parameters, file disposition parameters and/or other instructions/guidelines/parameters that are utilized for management of electronic records.

In one embodiment, mapping module 625 operates to determine/acquire data model information and/or classification information from the plurality of source systems (e.g., file management, document management, collaboration application) being managed. In one embodiment, mapping module 625 operates with fileplan manager 620 to cause the parameters/guidelines of fileplan manager 620 to be implemented through the various source systems that can have different data models and/or classification schemes.

In one embodiment, indexer 630 operates to index the electronic records created in the source systems. In one embodiment, indexer 630 generates/manages the index having a pointer to each electronic record in the various source systems. In one embodiment, indexer 630 operates to update the index with changes to electronic records. In one embodiment, indexer 630 operates with fileplan manager 620 and/or mapping module 625.

In one embodiment, metadata module 635 operates to manage the metadata utilized by records management agent 690. In one embodiment, metadata may be used to map to a file number or for other mapping purposes. In one embodiment, the record metadata is updated to include deletion information (e.g., time, data, authorized user). In one embodiment, record metadata is retained by records management agent 690 indefinitely.

In one embodiment, timer(s) 640 is/are utilized by fileplan manager 620 to implement elements of the fileplan having timing parameters. In one embodiment, retention and/or disposition is based on time parameters and timer(s) 640 may be utilized to providing the appropriate timing for these operations.

In one embodiment, schedule manager 645 operates to manage scheduling tasks performed by records management agent 690. In one embodiment, schedule manager 645 operates to track electronic records against the appropriate retention schedule and/or to identify which records are scheduled to be dispositioned. In one embodiment, schedule manager 645 operates with fileplan manager 620 to maintain current schedule information.

In one embodiment, search/hold module 650 operates to allow a party to search for electronic documents, for example, using a graphical user interface. In one embodiment, search/hold module 650 operates to allow electronic documents identified by the search to be placed on hold, which can flag, mark or other wise suspend normal retention operations. In one embodiment, documents placed on hold are not dispositioned even if the retention parameters otherwise indicate disposition is in order.

In one embodiment, disposition manager 655 operates to disposition electronic documents as appropriate. In one embodiment, disposition manager 655 communicates with fileplan manager 620 and/or search/hold module 650 to determine which electronic documents to disposition. In one embodiment, disposition manager 655 operates to cause electronic documents to be dispositioned when appropriate, for example, by issuing API calls and/or instructions to source systems.

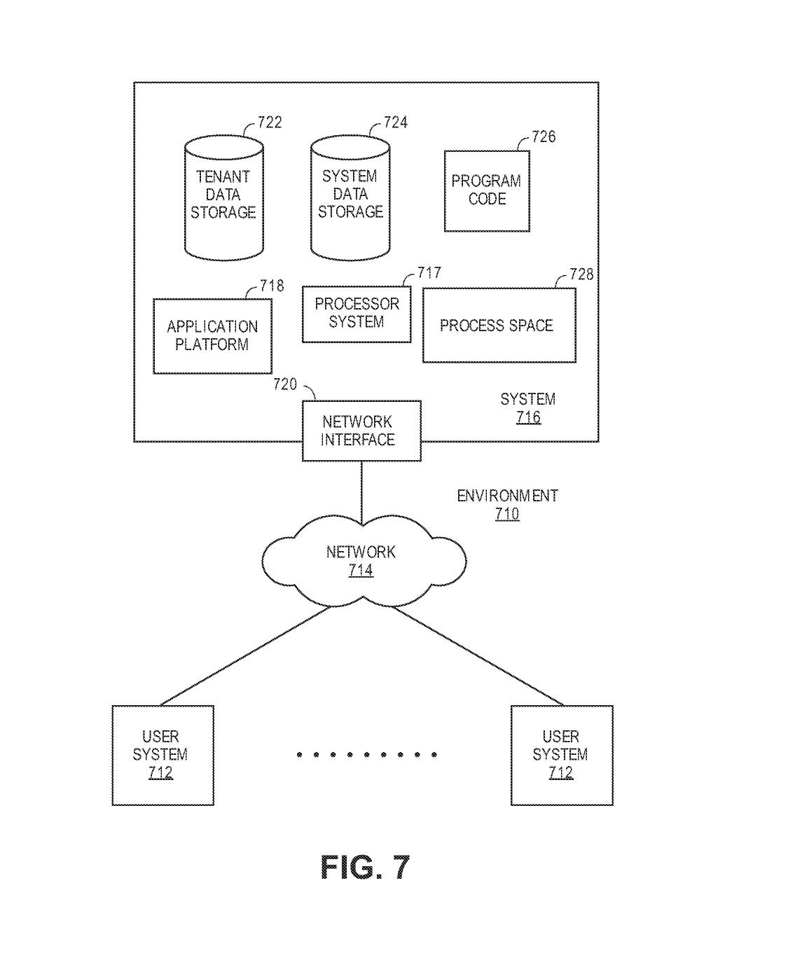

FIG. 7 illustrates a block diagram of an environment 710 wherein an on-demand database service might be used. Environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

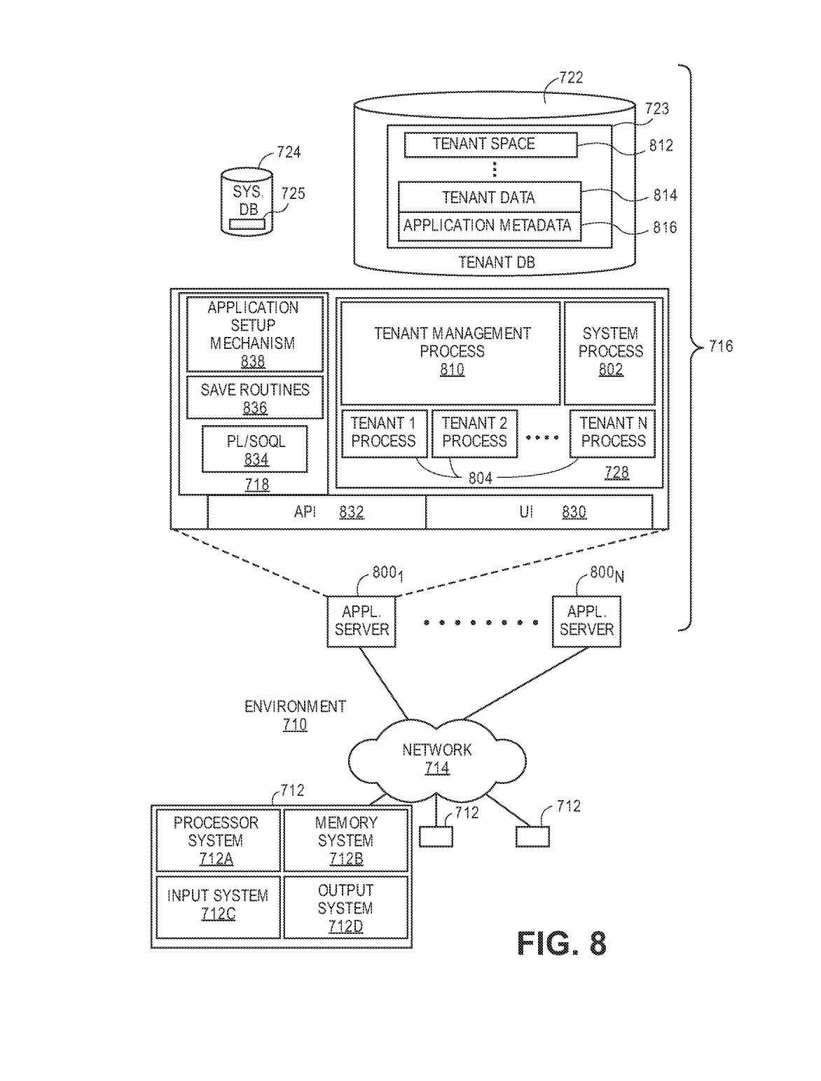

Environment 710 is an environment in which an on-demand database service exists. User system 712 may be any machine or system that is used by a user to access a database user system. For example, any of user systems 712 can be a handheld computing device, a mobile phone, a laptop computer, a work station, and/or a network of computing devices. As illustrated in herein FIG. 7 (and in more detail in FIG. 8) user systems 712 might interact via a network 714 with an on-demand database service, which is system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” will be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop, PDA, cell phone, or any wireless access protocol (WAP) enabled device or any other computing device capable of interfacing directly or indirectly to the Internet or other network connection. User system 712 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Pentium® processor or the like. Similarly, system 716 (and additional instances of an MTS, where more than one is present) and all of their components might be operator configurable using application(s) including computer code to run using a central processing unit such as processor system 717, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 also illustrates environment 710. However, in FIG. 8 elements of system 716 and various interconnections in an embodiment are further illustrated. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 800₁-400_{N}, system process space 802, tenant process spaces 804, tenant management process space 810, tenant storage space 812, tenant data 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage spaces 812, which can be either a physical arrangement and/or a logical arrangement of data. Within each tenant storage area 812, tenant data 814 and application metadata 816 might be similarly allocated for each user. For example, a copy of a user's most recently used (MRU) items might be stored to tenant data 814. Similarly, a copy of MRU items for an entire organization that is a tenant might be stored to tenant storage space 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800_{N} might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 Big-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

In one embodiment, the techniques described herein can provide improved reporting. In one embodiment, the system could record each disposition and provide the ability to report on compliance. In one embodiment, each disposition and the approving Records Manager could be captured and available for reporting.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A system comprising:
a plurality of source systems each to store electronic records, each having a different data model and classification scheme;
a document management agent communicatively coupled with the plurality of source systems, the document management agent to index the electronic records created in the plurality of source systems, the index having a pointer to each electronic record in the plurality of source systems, the document management agent to update the index with changes to electronic records, the document management agent to apply retention rules and track electronic records against the appropriate retention schedule, and identify which records are scheduled to be dispositioned, and when the disposition is appropriate, the document management agent to invoke deletion or exportation of the corresponding electronic records.

2. The system of claim 1 wherein the classification scheme comprises an inherent classification scheme to provide tagging of one or more of the records based on rules within the document management agent, wherein the rules are be based on the data model of the source system, the metadata on the electronic record mapped to a classification or an intelligent classification based on record content.

3. The system of claim 1 wherein the classification scheme comprises an acquired classification that takes place when an imported record is classified with a file number in one of the plurality of source systems.

4. The system of claim 1 wherein the plurality of source systems comprises at least one document management application and at least one collaboration application.

5. The system of claim 1 wherein the plurality of source systems comprises at least one messaging system and at least one collaboration application.

6. The system of claim 5 wherein the at least one messaging system comprises at least one social media application having an associated feed.

7. The system of claim 1 wherein the plurality of source systems comprises at least one document management application and at least messaging system.

8. The system of claim 7 wherein the at least one messaging system comprises at least one social media application having an associated feed.

9. A non-transitory computer-readable medium having stored thereon instructions that, when executed by one or more processors, cause the one or more processors to:
store electronic records in databases, each having a different data model and classification scheme;
index the electronic records created in the plurality of source systems, the index having a pointer to each electronic record in the plurality of source system;
update the index with changes to electronic records, the document management agent to apply retention rules and track electronic records against the appropriate retention schedule;
identify which records are scheduled to be dispositioned, and when the disposition is appropriate, the document management agent to invoke deletion or exportation of the corresponding electronic records.

10. The non-transitory computer-readable medium of claim 9 wherein the classification scheme comprises an inherent classification scheme to provide tagging of one or more of the records based on rules within the document management agent, wherein the rules are be based on the data model of the source system, the metadata on the electronic record mapped to a classification or an intelligent classification based on record content.

11. The non-transitory computer-readable medium of claim 9 wherein the classification scheme comprises an acquired classification that takes place when an imported record is classified with a file number in one of the plurality of source systems.

12. The non-transitory computer-readable medium of claim 9 wherein the plurality of source systems comprises at least one document management application and at least one collaboration application.

13. The non-transitory computer-readable medium of claim 9 wherein the plurality of source systems comprises at least one messaging system and at least one collaboration application.

14. The non-transitory computer-readable medium of claim 13 wherein the at least one messaging system comprises at least one social media application having an associated feed.

15. The non-transitory computer-readable medium of claim 9 wherein the plurality of source systems comprises at least one document management application and at least messaging system.

16. The non-transitory computer-readable medium of claim 15 wherein the at least one messaging system comprises at least one social media application having an associated feed.

17. A method comprising:
storing electronic records in a plurality of databases, each having a different data model and classification scheme;
indexing the electronic records created in the plurality of source systems, the index having a pointer to each electronic record in the plurality of source system;
updating the index with changes to electronic records, the document management agent to apply retention rules and track electronic records against the appropriate retention schedule;
identifying which records are scheduled to be dispositioned, and when the disposition is appropriate, the document management agent to invoke deletion or exportation of the corresponding electronic records.

18. The method of claim 17 wherein the classification scheme comprises an inherent classification scheme to provide tagging of one or more of the records based on rules within the document management agent, wherein the rules are be based on the data model of the source system, the metadata on the electronic record mapped to a classification or an intelligent classification based on record content.

19. The method of claim 17 wherein the classification scheme comprises an acquired classification that takes place when an imported record is classified with a file number in one of the plurality of source systems.

20. The method of claim 17 wherein the plurality of source systems comprises at least one document management application and at least one collaboration application.

21. The method of claim 17 wherein the plurality of source systems comprises at least one messaging system and at least one collaboration application.

22. The method of claim 21 wherein the at least one messaging system comprises at least one social media application having an associated feed.

23. The method of claim 17 wherein the plurality of source systems comprises at least one document management application and at least messaging system.

24. The method of claim 23 wherein the at least one messaging system comprises at least one social media application having an associated feed.
